(19) United States
(12) Patent Application Publication
(10) Pub. No.: US 2026/0229072 A1
(43) Pub. Date: Aug. 6, 2026

(54) METHOD AND SYSTEM FOR EXTRACTING ABNORMAL SCENES FROM DRIVING DATA OF INTELLIGENT VEHICLES BASED ON ARTIFICIAL INTELLIGENCE

(71) Applicant: Research Institute of Highway Ministry of Transport, Beijing (CN)

(72) Inventors: Yipeng Zhang, Beijing (CN); Zhenhua Li, Beijing (CN); Yanyue Liu, Beijing (CN); Qinglan Fan, Beijing (CN); Zhuomin Zhang, Beijing (CN); Mengyi Wu, Beijing (CN); Wei Zhang, Beijing (CN); Qihao Yin, Beijing (CN)

(21) Appl. No.: 19/301,861

(22) Filed: Aug. 15, 2025

(30) Foreign Application Priority Data
Feb. 5, 2025 (CN) 202510128990.5

(51) Int. Cl. G07C 5/04; B60W 50/00; B60W 50/04; G07C 5/00

(52) U.S. Cl. CPC G07C 5/04; B60W 50/045; G07C 5/008; B60W 2050/0025; B60W 2050/0034; B60W 2420/403; B60W 2420/408; B60W 2510/06; B60W 2510/227; B60W 2520/105; B60W 2530/13; B60W 2556/45

(57) ABSTRACT

The present disclosure provides a method and system for extracting abnormal scenes from driving data of intelligent vehicles based on artificial intelligence (AI). In the present disclosure, basic information of intelligent vehicles is acquired from a plurality of data transmission terminals through an intelligent vehicle driving data abnormal scene extraction method based on AI, abnormal risks are analyzed and evaluated, a data extraction ratio is dynamically adjusted, and risk vehicles are efficiently identified. Professional modules are used to mine data features, and abnormal scenes are marked by cluster analysis to improve the efficiency of data analysis.

### CROSS-REFERENCE TO RELATED APPLICATION

This application claims priority of Chinese Patent Application No. 202510128990.5 filed on Feb. 5, 2025, the entire contents of which are incorporated herein by reference.

### TECHNICAL FIELD

The present disclosure relates to the field of data analysis, and in particular to a method and system for extracting abnormal scenes from driving data of intelligent vehicles based on artificial intelligence (AI).

### BACKGROUND

With the development of AI technology, intelligent vehicles have become an important research direction in the automotive industry. Intelligent vehicles are equipped with various sensors (including radar, cameras, lidar, etc.) and advanced computing systems to realize the perception, decision-making and control of the surrounding environment, thereby realizing partial or fully autonomous driving functions. However, intelligent vehicles may encounter various abnormal scenarios in complex actual traffic environments, which are often the main causes of traffic accidents. Therefore, how to effectively extract and identify these abnormal scenes is crucial to improve the safety and reliability of intelligent vehicles.

In the related art, the disclosure patent with a publication number of CN113992533B provides a vehicle-mounted controller area network (CAN) bus data abnormality detection and identification method. The modified self-attention mechanism is used to integrate the model structure of multi-layer gated recurrent unit (GRU) network, and the characters of self-attention mechanism are used to enhance the time series features of data. The multi-layer GRU network is used to further extract the features of multi-dimensional time series data and improve the recognition accuracy of CAN bus data.

In the related art, the disclosure patent with a publication number of CN111448783B provides an on-vehicle network abnormality detection system and an on-vehicle network abnormality detection method. The in-vehicle network abnormality detection system includes: a first communication unit, configured to receive first unit data as communication unit data under a first protocol from a first network; an abnormality determination database including information of an abnormality determination rule; an abnormality determination unit, configured to determine the presence or absence of abnormality in the first unit data using the abnormality determination rule; a unit data conversion unit, configured to extract second unit data as communication unit data under a second protocol from the first unit data determined by the abnormality determination unit as not including abnormality; and a second communication unit, configured to transmit the extracted second unit data to the second network. The first unit data includes transmission source information indicating a first device as a transmission source, and the second unit data includes a data identifier; and the abnormality determination unit executes predetermined abnormality response processing when it is determined that the first unit data includes an abnormality by comparing the combination of the transmission source information and the data identifier with an abnormality determination rule.

Based on the above technical solutions, it can be seen that in the field of abnormal scene detection in the related art, the data collection source is relatively single, and the data processing method needs to consume a large amount of computing resources. However, in practical applications, different intelligent vehicles may face different abnormal scenes, and the abnormal scene risks of different intelligent vehicles are also different. If only data from a single source is analyzed, the analysis results may not be universal.

### SUMMARY

Given the deficiency of the related art, the present disclosure provides a method and system for extracting abnormal scenes from driving data of intelligent vehicles based on AI. In order to achieve the above objectives, the present disclosure is realized through the following technical solutions. The method and system for extracting abnormal scenes from driving data of intelligent vehicles based on AI includes steps of:
retrieving basic information of various intelligent vehicles from a plurality of data transmission terminals, and analyzing and processing the basic information to obtain abnormal risk assessment values of the various intelligent vehicles, followed by matching to obtain a driving data extraction ratio of each intelligent vehicle based on the abnormal risk assessment values of the various intelligent vehicles,
acquiring driving data packets of each intelligent vehicle based on the driving data extraction ratio of each intelligent vehicle, simultaneously acquiring time points marked with driving abnormalities, statistically recording comprehensive scene data of the time points marked with driving abnormalities from the driving data packets, performing classified data processing, and importing the processed data into an integrated AI cloud computing center, and
receiving the processed comprehensive scene data of time points marked with driving abnormalities by the integrated AI cloud computing center, and performing clustering processing to generate and store abnormal scene data of each intelligent vehicle.

In a preferred technical solution, the retrieving basic information of each intelligent vehicle from a plurality of data transmission terminals specifically includes the steps of:
initiating a connection request from the integrated AI cloud computing center to each data transmission terminal, and packaging and transmitting the basic information of each intelligent vehicle to a central server of the integrated AI cloud computing center after each data transmission terminal receives the connection request,
the basic information of each intelligent vehicle including an accumulated mileage, an accumulated duration, and an accumulated number of failures of each intelligent vehicle.

In a preferred technical solution, the analyzing and processing the basic information to obtain abnormal risk assessment values of each intelligent vehicle specifically includes the steps of:
analyzing and processing the basic information of each intelligent vehicle to obtain a basic information average value set and a basic information median value set,
the basic information average value set including an accumulated average mileage, an accumulated average duration, and an accumulated average number of failures; and
the basic information median value set including a median value of accumulated mileage, a median value of accumulated duration, and a median value of accumulated number of failures;
comprehensively analyzing and processing the basic information average value set and the basic information median value set to obtain a basic information median adjusted average value set, including an accumulated median adjusted average mileage, an accumulated median adjusted average duration and an accumulated median adjusted average number of failures; and
comparing and analyzing the basic information of each intelligent vehicle and the basic information median adjusted average value set to obtain the abnormal risk assessment value of each intelligent vehicle, and the abnormal risk assessment value of each intelligent vehicle being used to characterize abnormal risks of each intelligent vehicle during driving.

In a preferred technical solution, the matching to obtain a driving data extraction ratio of each intelligent vehicle based on the abnormal risk assessment values of each intelligent vehicle specifically includes the steps of:
performing mapping and matching on a driving data extraction ratio corresponding to each abnormal risk assessment value interval in a built-in database of the integrated AI cloud computing center based on the abnormal risk assessment value of each intelligent vehicle, and obtaining a driving data extraction ratio of each intelligent vehicle.

In a preferred technical solution, the acquiring time points marked with driving abnormalities, and statistically recording comprehensive scene data of the time points marked with driving abnormalities from the driving data packets specifically includes the steps of:
identifying time points marked with driving abnormalities in the driving data packets of each intelligent vehicle, statistically recording longitudinal abnormality time point data and horizontal abnormality time period data of the time points marked with driving abnormalities, and synthesizing the same as the comprehensive scene data of time points marked with driving abnormalities;
the comprehensive scene data of the time points marked with driving abnormalities including environmental perception data and control system data of the time points marked with driving abnormalities,
the environment perception data including the image data, the point cloud data, and the radar data of the time points marked with driving abnormalities; and
the control system data including an engine response time, a braking deceleration, a braking distance, a suspension compression amount, and a suspension rebound speed of the time points marked with driving abnormalities.

In a preferred technical solution, the performing classified data processing, and importing the processed data into an integrated AI cloud computing center specifically includes the steps of:
importing image data, point cloud data and radar data of the time points marked with driving abnormalities into an image feature extraction module, a point cloud geometric feature extraction module and a radar feature extraction module local to the AI cloud computing center, and performing corresponding data processing to obtain image feature data, point cloud geometric feature data and radar feature data of the time points marked with driving abnormalities;
comparing and analyzing control system data of the time points marked with driving abnormalities with a pre-stored control system data check set in a local database to obtain a control system state characteristic value of the time points marked with driving abnormalities, in which the control system state characteristic value of the time points marked with driving abnormalities is used for confirming whether a control system of time points marked with driving abnormalities is normal or not, it is determined that the control system of at a certain time point marked with driving abnormality is abnormal if the control system state characteristic value at the certain time point marked with driving abnormality is greater than or equal to a preset control system state abnormal threshold value, and it is determined that the control system state characteristic value at a certain time point marked with driving abnormality is normal if the control system state characteristic value at the certain time point marked with driving abnormality is less than the control system state abnormal threshold value;
statistically recording the time points marked with driving abnormalities when the control system is abnormal as time points marked with each abnormal control system, and storing image feature data, point cloud geometric feature data and radar feature data of the time points marked with each abnormal control system in a database under a label of the abnormal control system;
the control system data check set including an engine response time threshold, a braking deceleration threshold, a braking distance threshold, a suspension compression threshold, and a suspension rebound speed threshold; and
collectively recording the image feature data, the point cloud geometric feature data, and the radar feature data of the time points marked with driving abnormalities when the control system is normal as processed comprehensive scene data of the time points marked with driving abnormalities.

In a preferred technical solution, the receiving the processed comprehensive scene data of time points marked with driving abnormalities by the integrated AI cloud computing center, and performing clustering processing to generate and store abnormal scene data of each intelligent vehicle specifically includes the steps of:
receiving the processed comprehensive scene data of the time points marked with driving abnormalities by the integrated AI cloud computing center, performing K-means clustering processing and analysis to obtain a plurality of abnormal scene characteristic clusters of the time points marked with driving abnormalities, obtaining data features of each abnormal cluster of the time points marked with driving abnormalities after iterative update, and matching the data features of each abnormal cluster of time points marked with driving abnormalities with corresponding abnormal scene labels pre-stored in the integrated AI cloud computing center to obtain each abnormal scene label of the time points marked with driving abnormalities; and
storing the processed comprehensive scene data of time points marked with driving abnormalities in a database under each corresponding abnormal scene label based on each abnormal scene label of the time points marked with driving abnormalities.

In a preferred technical solution, the method further includes detecting transmission channel performance parameters from each data transmission terminal to the integrated AI cloud computing center, processing, analyzing and generating data quality repair factor and performing data quality repair, specifically including the steps of:
the transmission channel performance parameters including a real-time signal strength, an interface rate, real-time delay and real-time signal-to-noise ratio (SNR) of each data transmission terminal;
retrieving transmission channel performance verification parameters from the built-in database of the integrated AI cloud computing center, including a real-time signal strength check value, an interface rate check value, a real-time delay check value and a real-time SNR check value; and
comprehensively comparing and analyzing the transmission channel performance parameters and the transmission channel performance verification parameters to obtain data quality influence values of each transmission channel, mapping and matching the data quality influence values of each transmission channel with data quality repair factors corresponding to data quality influence value intervals pre-stored in the built-in database of the integrated AI cloud computing center to obtain data quality repair factors of each transmission channel; and the data quality influence values of each transmission channel being used to characterize the influence of the performance of each transmission channel on the data quality, and repairing data quality based on the data transmission repair factors.

In a preferred technical solution, the analyzing and processing the basic information to obtain abnormal risk assessment values of each intelligent vehicle specifically includes the steps of:

$${A}_{m} = softplus [ \frac{{L}_{m}}{{L}_{re}} * {μ}_{1} + \frac{{T}_{m}}{{T}_{re}} * {μ}_{2} + \frac{{L}_{m}}{{C}_{re}} * {μ}_{3} ]$$

where Aₘ is an abnormal risk assessment value of the mₜₕ intelligent vehicle, Lₘ is an accumulated mileage of the mₜₕ intelligent vehicle, Tₘ is an accumulated duration of the mₜₕ intelligent vehicle, and Lₘ is an accumulated number of failures of the mₜₕ intelligent vehicle; Lᵣₑ is an accumulated median adjusted average mileage, Tᵣₑ is an accumulated median adjusted average duration and Cᵣₑ is an accumulated median adjusted average number of failures; and μ₁ is a weight factor of the accumulated mileage, μ₂ is a weight factor of the accumulated duration, μ₃ is a weight factor of the accumulated average number of failures, m is a number of the intelligent vehicle, m=1, 2, 3, . . . , y, y is a total number of intelligent vehicles, and the softplus function is a built-in function in Python, softplus(x)=lg(1+e^{x}).

A system for extracting abnormal scenes from driving data of intelligent vehicles based on AI includes:
an abnormal risk assessment module, configured to retrieve the basic information of each intelligent vehicle from a plurality of data transmission terminals, analyze and process the basic information to obtain abnormal risk assessment values of each intelligent vehicle, and obtain a driving data extraction ratio of each intelligent vehicle through matching based on the abnormal risk assessment values of each intelligent vehicle;
a data extraction module, configured to acquire driving data packets of each intelligent vehicle based on the driving data extraction ratio of each intelligent vehicle, simultaneously acquire time points marked with driving abnormalities, statistically record comprehensive scene data of the time points marked with driving abnormalities from the driving data packets, perform classified data processing, and import the processed data into an integrated AI cloud computing center; and
a scene extraction module, configured to receive the processed comprehensive scene data of time points marked with driving abnormalities by the integrated AI cloud computing center, and perform clustering processing to generate and store abnormal scene data of each intelligent vehicle.

Compared with the related art, the examples of the present disclosure have at least the following beneficial effects.

In the method and system for extracting abnormal scenes from driving data of intelligent vehicles based on AI provided by the present disclosure, by retrieving the basic information of the intelligent vehicles from a plurality of data transmission terminals, comprehensive data can be acquired, the basic information of the intelligent vehicles can be analyzed and processed to obtain the abnormal risk assessment values, and the driving data extraction ratio can be dynamically adjusted to effectively allocate data acquisition resources and improve efficiency.

In the present disclosure, by statistically analyzing the comprehensive scene data, including environmental perception data and control system data, a thorough analysis of the driving environment is conducted. The image feature extraction module, the point cloud geometric feature extraction module and the radar data processing module are used to classify the data, and the feature information in the data is deeply mined. Through clustering analysis, different abnormal scenes can be identified, and each scene can be labeled to facilitate subsequent data storage and analysis.

In the present disclosure, by detecting the performance parameters of the data transmission channel and generating the data quality repair factor, the integrity and accuracy of the data in the transmission process are guaranteed, the maintenance cost is reduced and the data processing efficiency is improved.

Certainly, it is not necessary for any product implementing the present disclosure to achieve all the advantages mentioned above at the same time.

### BRIEF DESCRIPTION OF THE DRAWINGS

FIG. 1 is a schematic flow diagram of a method of the present disclosure.

FIG. 2 is a schematic diagram of system modules of the present disclosure.

### DETAILED DESCRIPTION

Technical solutions in the examples of the present disclosure will be described clearly and completely in the following with reference to the accompanying drawings in the examples of the present disclosure. Obviously, all the described examples are only some, rather than all examples of the present disclosure. Based on the examples in the present disclosure, all other examples obtained by those ordinary skilled in the art without creative efforts belong to the protection scope of the present disclosure.

In the description of the present disclosure, it is to be understood that the terms “aperture”, “upper”, “lower”, “thickness”, “top”, “middle”, “length”, “inner”, “surrounding”, etc. indicate orientation or positional relationships only for the objective of facilitating and simplifying the description of the present disclosure, and do not indicate or imply that the component or element referred to must have a specific orientation, be constructed and operate in a specific orientation, and therefore are not to be construed as limiting the present disclosure.

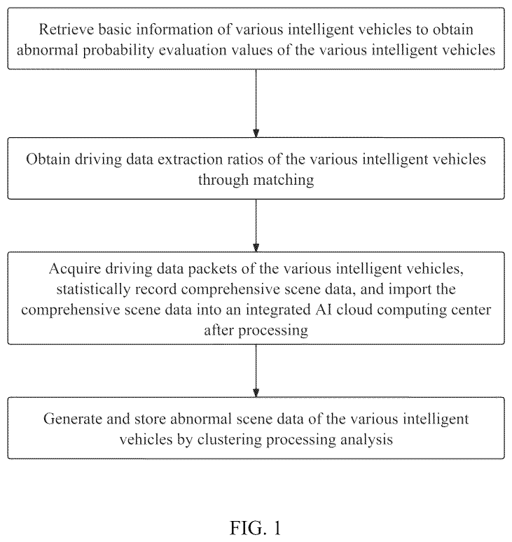

Referring to FIG. 1, an example of the present disclosure provides a method for extracting abnormal scenes from driving data of intelligent vehicles based on AI, including the following steps.

Basic information of various intelligent vehicles is retrieved from a plurality of data transmission terminals, the basic information is analyzed and processed to obtain abnormal risk assessment values of various intelligent vehicles, and the driving data extraction ratios of various intelligent vehicles are matched and obtained based on the abnormal risk assessment values of various intelligent vehicles.

Basic information of various intelligent vehicles is retrieved from a plurality of data transmission terminals, specifically including the following steps.

A connection request is initiated from the integrated AI cloud computing center to each data transmission terminal, and the basic information of each intelligent vehicle is packaged and transmitted to a central server of the integrated AI cloud computing center after each data transmission terminal receives the connection request.

The integrated AI cloud computing center is an integrated cloud processor for receiving, transmitting, calculating, retrieving and storing data in the example of the present disclosure.

In an example of the present disclosure, each data transmission terminal is a data transmission port configured in advance for each intelligent vehicle, and is used to transmit basic information and driving data packets of each intelligent vehicle.

The basic information of each intelligent vehicle includes an accumulated mileage, an accumulated duration, and an accumulated number of failures of each intelligent vehicle, and the basic information of each intelligent vehicle is obtained by retrieving a driving record log of each intelligent vehicle.

The accumulated mileage refers to a total mileage traveled by the intelligent vehicle left a factory to the current time point. The intensity of vehicle usage can be assessed by the accumulated mileage.

The accumulated duration refers to accumulated driving time of the intelligent vehicle left the factory to the current time point. The average running time and idle time of the vehicle can be known through the accumulated duration, thereby evaluate the running efficiency of the vehicle. Vehicle running for a long time may lead to the aging of vehicle components, and the accumulated time is helpful to evaluate the overall condition of the vehicle.

The accumulated number of failures refers to a total number of failures that have occurred since the intelligent vehicle left the factory to the current time point. The reliability of the vehicle can be evaluated by the number of failures.

The basic information is analyzed and processed to obtain abnormal risk assessment values of each intelligent vehicle, specifically including the following steps.

The basic information of each intelligent vehicle is analyzed and processed to obtain a basic information average value set and a basic information median value set.

The basic information average value set includes an accumulated average mileage, an accumulated average duration, and an accumulated average number of failures.

The basic information median value set includes a median value of accumulated mileage, a median value of accumulated duration, and a median value of accumulated number of failures.

The basic information average value set and the basic information median value set are comprehensively analyzed and processed to obtain a basic information median adjusted average value set, including an accumulated median adjusted average mileage, an accumulated median adjusted average duration and an accumulated median adjusted average number of failures.

The basic information of each intelligent vehicle and the basic information median adjusted average value set are compared and analyzed to obtain the abnormal risk assessment value of each intelligent vehicle, and the abnormal risk assessment value of each intelligent vehicle is used to characterize abnormal risks of each intelligent vehicle during driving.

The basic information is analyzed and processed to obtain abnormal risk assessment values of each intelligent vehicle, specifically including the following steps.

$$\begin{matrix}{A}_{m} = softplus [ \frac{{L}_{m}}{{L}_{re}} * {μ}_{1} + \frac{{T}_{m}}{{T}_{re}} * {μ}_{2} + \frac{{L}_{m}}{{C}_{re}} * {μ}_{3} ] \\ {L}_{re} = {ω}_{1} * \overline{L} + {ω}_{2} * {L}_{middle} \\ {T}_{re} = {ω}_{1} * \overline{T} + {ω}_{2} * {T}_{middle} \\ {C}_{r e} = {ω}_{1} * \overline{C} + {ω}_{2} * {C}_{middle}\end{matrix}$$

where Aₘ is an abnormal risk assessment value of mₜₕ intelligent vehicle, Lₘ is an accumulated mileage of mₜₕ intelligent vehicle, Tₘ is an accumulated duration of mₜₕ intelligent vehicle, and Lₘ is an accumulated number of failures of mₜₕ intelligent vehicle; L̅ is an accumulated average mileage, T̅ is an accumulated average duration, and C̅ is an accumulated average number of failures; L_{middle} is a median value of accumulated mileage, T_{middle} is a median value of accumulated duration, and C_{middle} is a median value of accumulated number of failures; Lᵣₑ is an accumulated median adjusted average mileage, Tᵣₑ is an accumulated median adjusted average duration, and Cᵣₑ is an accumulated median adjusted average number of failures; μ₁ is a weight factor of the accumulated mileage, μ₂ is a weight factor of the accumulated duration, and μ₃ is a weight factor of the accumulated average number of failures; and ω₁ is an average value adjustment proportional coefficient, ω₂ is a median value adjustment proportional coefficient, m is a number of the intelligent vehicle, m=1, 2, 3, . . . , y, y is a total number of intelligent vehicles, and the softplus function is a built-in function in Python, softplus (x)=lg (1+e^{x}).

It is to be noted that the average value adjustment scale coefficient and the median adjustment scale coefficient both range from 0 to 1, and satisfy ω₁+ω₂=1. The average value adjustment scale coefficient is an influence factor of the median adjustment average value in the basic information preset in the integrated AI cloud computing center, and represents a numerical value of the influence degree of the average value on the median adjustment average value in the basic information. The median adjustment proportional coefficient is an influence factor of the median adjustment average value in the basic information preset in the integrated AI cloud computing center, and is a numerical value indicating the influence degree of the median value on the median adjustment average value in the basic information. When in use, the average value adjustment scale coefficient and the median value adjustment scale coefficient can be directly acquired from the integrated AI cloud computing center, and the corresponding relationship is a preset mapping relationship. For example, the basic information of each intelligent vehicle involved in this example of the present disclosure includes the accumulated mileage, the accumulated duration, and the accumulated number of failures of each intelligent vehicle; and after calculating the average value and median value, the mapping set is inputted for mapping matching to obtain the average value adjustment proportional coefficient and the median value adjustment proportional coefficient involved in this example of the present disclosure, and the mapping relationship is one-to-one correspondence.

It is to be noted that the weight factor of the accumulated mileage, the weight factor of the accumulated duration, and the weight factor of the accumulated average number of failures all range from 0 to 1, and satisfy μ₁+μ₂+/μ₃=1. The weight factor of the accumulated mileage is an influence factor of the abnormal risk assessment value of each intelligent vehicle preset in the integrated AI cloud computing center, and represents an influence degree of accumulated mileage on the abnormal risk assessment value of each intelligent vehicle. The weight factor of the accumulated duration is an influence factor of the abnormal risk assessment value of each intelligent vehicle preset in the integrated AI cloud computing center, and represents an influence degree of accumulated duration on the abnormal risk assessment value of each intelligent vehicle. The weight factor of the accumulated average number of failures is an influence factor of the abnormal risk assessment value of each intelligent car preset in the integrated AI cloud computing center, and represents an influence degree of the accumulated average number of failures on the abnormal risk assessment value of each intelligent car. When in use, the weight factor of the accumulated mileage, the weight factor of the accumulated duration, and the weight factor of the accumulated average number of failures can be directly obtained from the integrated AI cloud computing center by a preset mapping relationship. For example, the basic information of each intelligent vehicle involved in this example of the present disclosure includes the accumulated mileage, the accumulated duration, and the accumulated number of failures of each intelligent vehicle; and a preset mapping set in a database is input for mapping and matching to obtain the weight factor of the accumulated mileage, the weight factor of the accumulated duration, and the weight factor of the accumulated average number of failures, and the mapping relationship is one-to-one correspondence.

It is also to be noted that the basic information of each intelligent vehicle includes the accumulated mileage, the accumulated duration, and the accumulated number of failures of each intelligent vehicle, these parameters have a certain correlation and are inseparable from each other, and in general, the accumulated mileage and the accumulated duration are directly related. The longer the mileage the vehicle travels, the more time it usually takes. The relationship between these two parameters is also affected by the average speed of the vehicle. The faster the speed, the more mileage accumulated in the same time; and the slower the speed, the less mileage accumulated in the same time. With the increase of accumulated mileage, vehicle components may be more prone to failure due to wear, and these two parameters show a positive correlation. The vehicle running for a long time may lead to overheating or fatigue of vehicle components, thereby increasing the number of failures. In the absence of other factors, the accumulated mileage and accumulated duration are usually positively correlated with the accumulated number of failures, that is, the number of failures may also increase when the mileage or duration increases.

The driving data extraction ratio of each intelligent vehicle is matched and obtained based on the abnormal risk assessment values of each intelligent vehicle, specifically including the following steps.

Mapping and matching are performed on the driving data extraction ratio corresponding to each abnormal risk assessment value interval in a built-in database of the integrated AI cloud computing center based on the abnormal risk assessment value of each intelligent vehicle, and the driving data extraction ratio of each intelligent vehicle is obtained.

The driving data extraction ratio of each intelligent vehicle is used to determine the driving data extraction amount of each intelligent vehicle, and for example, when the driving data extraction ratio corresponding to the abnormal risk assessment value of a certain intelligent vehicle is 20%, 20% of the driving data of the intelligent vehicle is selected.

By matching the abnormal risk assessment value of each intelligent vehicle, the corresponding driving data extraction ratio is obtained, and different data extraction strategies are formulated according to risk levels of different vehicles. High-risk vehicles will be allocated a higher data extraction ratio, ensuring that more resources are invested in the high-risk intelligent vehicles, while reducing unnecessary data collection and data storage and processing costs.

It is to be noted that the example of the present disclosure further includes detecting transmission channel performance parameters from each data transmission terminal to the integrated AI cloud computing center, processing, analyzing and generating data quality repair factor and performing data quality repair, specifically including the following steps.

The transmission channel performance parameters include a real-time signal strength, an interface rate, real-time delay and real-time SNR.

The real-time signal strength refers to the strength of a signal level in the transmission channel, usually expressed in decibels (dB). The signal strength is directly related to the transmission distance and anti-interference ability of the signal. The higher the signal strength, the longer the transmission distance, and the stronger the ability to resist external interference. If the signal strength is too low, it may cause data transmission errors or interruptions.

The interface rate refers to a transmission rate of a data transmission channel, usually expressed in bits per second (bps) or megabits per second (Mbps). The interface rate determines the speed of data transmission. The higher the rate, the greater the amount of data that can be transmitted per unit time.

The real-time delay refers to the time required for data from a sender to a receiver, usually measured in milliseconds (ms). The lower the delay, the better the real-time performance of the data. High delay may cause the real-time performance of data transmission to degrade and affect the performance of the application.

Real-time SNR refers to a ratio of signal power to noise power, usually expressed in dB. SNR is an important parameter to measure signal quality. The higher the SNR, the greater the proportion of effective information in the signal to noise, and the higher the reliability of data transmission. A low SNR means a high level of noise, which can lead to data transmission errors or packet loss.

Transmission channel performance verification parameters are retrieved from the built-in database of the integrated AI cloud computing center, including a real-time signal strength check value, an interface rate check value, a real-time delay check value and a real-time SNR check value.

The transmission channel performance parameters and the transmission channel performance verification parameters are comprehensively compared and analyzed to obtain data quality influence values of each transmission channel, and the data quality influence values of each transmission channel are mapped and matched with data quality repair factors corresponding to data quality influence value intervals pre-stored in the built-in database of the integrated AI cloud computing center to obtain data quality repair factors of each transmission channel. The greater the data quality influence value, the greater the data quality repair factor, and the data quality repair factor of each transmission channel is used to repair the loss occurring in the process of data transmission from each data transmission terminal to the integrated AI cloud computing center.

The data quality influence values of each transmission channel is obtained, specifically including the following steps:

$${B}_{Z} = exp [ \frac{{YC}_{z}}{{YC}_{0}} * {α}_{1} + {( \frac{{XH}_{z}}{{XH}_{0}} * {α}_{2} + \frac{{V}_{z}}{{V}_{0}} * {α}_{3} + \frac{{XZB}_{Z}}{{XZB}_{0}} * {α}_{4} )}^{- 1} ]$$

where B_{z} is a data quality influence value of zₜₕ transmission channel, XH_{z} is a real-time signal strength of zₜₕ transmission channel, V_{z} is an interface rate of zₜₕ transmission channel, YC_{z} is a real-time delay of zₜₕ transmission channel, and XZB_{z} is a real-time SNR of zₜₕ transmission channel; XH₀ is a real-time signal strength check value, V₀ is an interface rate check value, YC₀ is a real-time delay check value, and XZB₀ is a real-time SNR check value; z is a number of transmission channels, z=1, 2, 3, . . . , w, and w is a total number of transmission channels; and α₁ is a real-time delay weight factor, α₂ is a real-time signal strength weight factor, α₃ is an interface rate weight factor and α₄ is a real-time SNR weight factor.

It is to be noted that the real-time delay weight factor, the real-time signal strength weight factor, the interface rate weight factor and the real-time SNR weight factor all range from 0 to 1, and satisfy α₁+α₂+α₃+α₄=1. The real-time delay weight factor is an influence factor corresponding to the data quality influence value of each transmission channel preset in the integrated AI cloud computing center, and represents an influence degree of real-time delay on the data quality influence value of each transmission channel. The real-time signal strength weight factor is an influence factor corresponding to the data quality influence value of each transmission channel preset in the integrated AI cloud computing center, and represents a numerical value of the influence degree of the real-time signal strength on the data quality influence value of each transmission channel. The interface rate weight factor is an influence factor corresponding to the data quality influence value of each transmission channel preset in the integrated AI cloud computing center, and represents a numerical value of an influence degree of the interface rate on the data quality influence value of each transmission channel. The real-time SNR weight factor is an influence factor corresponding to the data quality influence value of each transmission channel preset in the integrated AI cloud computing center, and represents a numerical value of an influence degree of the real-time SNR on the data quality influence value of each transmission channel. When in use, the real-time delay weight factor, the real-time signal strength weight factor, the interface speed weight factor and the real-time SNR weight factor can be directly obtained from the integrated AI cloud computing center by a preset mapping relationship. For example, the data quality influence values of each transmission channel involved in this example of the present disclosure, such as the transmission channel performance parameters including the real-time signal strength, the interface rate, the real-time delay and the real-time SNR; and the preset mapping set in the database is input for mapping matching to obtain the real-time delay weight factor, the real-time signal strength weight factor, the interface speed weight factor and the real-time SNR weight factor involved in this example of the present disclosure, and the mapping relationship is one-to-one correspondence.

It is to be noted that the transmission channel performance parameters include the real-time signal strength, the interface rate, the real-time delay and the real-time SNR, these parameters have certain correlation and are inseparable from each other, and the real-time signal strength is an integral part of the real-time SNR. The higher the signal strength, generally the higher the SNR, as a ratio of signal power to noise power increases. The real-time signal strength can affect the interface rate. If the signal strength is high enough, the transmission channel can support higher data rates. On the contrary, if the signal strength decreases, it may cause the transmission rate to decrease, because the system may need to decrease the rate to ensure the reliability of the data. The real-time SNR is an important factor affecting the interface rate. A high SNR can support higher data rates because there is more valid information in the signal, and the error rate is lower. A low SNR may lead to data transmission errors, thereby requiring retransmission of data, which will reduce the actual effective transmission rate. The real-time signal strength and the real-time SNR are interrelated, and jointly determine the clarity and transmission quality of the signal. The interface rate is affected by the real-time signal strength and the real-time SNR, because these parameters determine the capability and reliability of the transmission channel. The real-time delay may be affected by all other parameters, because the real-time delay reflects the time required for data from the sender to the receiver, and this time is affected by signal quality, transmission rate and network conditions.

The loss is repaired occurring in the process of data transmission from each data transmission terminal to the integrated AI cloud computing center, specifically including the following steps.

Based on the data quality repair factor of each transmission channel, the data quality repair parameter set is matched with the data quality repair parameter set corresponding to the data quality repair factor of each transmission channel pre-stored in the integrated AI cloud computing center to obtain a data quality repair parameter set of each transmission channel, and the data quality repair parameter set includes a data cleaning ratio adjustment value, a data filling ratio adjustment value and a data deduplication ratio adjustment value.

The greater the data quality repair factor, the greater the data quality repair parameter set including the data cleaning ratio adjustment value, the data filling ratio adjustment value and the data deduplication ratio adjustment value.

Based on the data quality repair parameter set of each transmission channel, corresponding data quality repair is performed on the transmitted basic information and driving data packets of each intelligent vehicle. For example, if the data cleaning ratio adjustment value of a certain transmission channel is 30%, the data filling ratio adjustment value is 20%, and the data deduplication ratio adjustment value is 15%, the basic information and driving data packets of each intelligent vehicle transmitted by the transmission channel are cleaned, filled, and deduplicated in a corresponding proportion.

The driving data packets of each intelligent vehicle are acquired based on the driving data extraction ratio of each intelligent vehicle, time points marked with driving abnormalities are simultaneously acquired, comprehensive scene data of the time points marked with driving abnormalities is statistically recorded from the driving data packets, classified data processing is performed, and the processed data is imported into an integrated AI cloud computing center.

The time points marked with driving abnormalities are acquired, and the comprehensive scene data of the time points marked with driving abnormalities is statistically recorded from the driving data packets, specifically including the following steps.

The time point marked with driving abnormality in the driving data packet of each intelligent vehicle is identified, the time point marked with driving abnormality in the driving data packet of each intelligent vehicle is integrated into time points marked with driving abnormalities, the longitudinal abnormality time point data and the lateral abnormality time period data of time points marked with driving abnormalities are statistically collected, and are integrated as the comprehensive scene data of time points marked with driving abnormalities.

The longitudinal abnormality time point data of time points marked with driving abnormalities is used to locate the position of time points marked with driving abnormalities in the driving data packet.

The transverse abnormality time period data is data included in time periods before and after time points marked with driving abnormalities is intercepted by the preset time period length of each intelligent vehicle after locating the positions of time points marked with driving abnormalities in the driving data packet, and the data is recorded as the comprehensive scene data of time points marked with driving abnormalities.

The preset time period length of each intelligent vehicle specifically includes the following.

Based on the abnormal risk assessment value of each intelligent vehicle, the preset time period length corresponding to each abnormal risk assessment value interval in the database is mapped and matched to obtain the preset time period length of each intelligent vehicle. The higher the abnormal risk assessment value of a intelligent vehicle, the longer the corresponding preset time period.

The comprehensive scene data of the time points marked with driving abnormalities includes environmental perception data and control system data of the time points marked with driving abnormalities.

The environment perception data includes the image data, the point cloud data, and the radar data of the time points marked with driving abnormalities.

The image data includes front, rear, side, top and upward scene images of each intelligent vehicle acquired by a driving recorder and an external integrated camera.

The point cloud data includes edge three-dimensional (3D) coordinates of each object in the scene, laser intensity and reflectivity of laser pulses, and is obtained by a laser radar sensor, where the edge 3D coordinate refers to a spatial position of each point on the edge of the object in the scene, which is usually represented by (X, Y, Z). The edge 3D coordinate is used to determine the exact position of the object in a 3D space (i.e. anomalous scene). The 3D shape and structure of the object can be reconstructed by the edge coordinates. Laser intensity refers to an intensity value returned by laser pulse emitted by a lidar after being reflected by the object. Objects of different materials reflect different laser intensities, which are used to identify the material of the object. The laser intensity can reflect the smoothness or roughness of the surface of the object. The reflectivity of a laser pulse refers to a proportion of light reflected back to a sensor after the laser pulse interacts with the surface of the object. Different objects have different reflectivity, which is used to classify objects and detect obstacles.

The radar data includes distance information, speed information, and radar cross section (RCS), and the distance information is calculated by emitting pulses by a transmitter and measuring the time of reflection back, including a straight line distance between each intelligent vehicle and other objects in the scene. The speed information is measured by a laser velocimeter, including the absolute speed and the relative speed of each intelligent vehicle and other objects in the scene. RCS is the ability of the object to reflect radar signals and is used to estimate the size and shape of objects in the scene.

The control system data includes an engine response time, a braking deceleration, a braking distance, a suspension compression amount, and a suspension rebound speed at time points marked with driving abnormalities, and is obtained by an on-board diagnostic system.

The engine response time refers to the time from the issuance of an acceleration request command (for example, pressing the accelerator pedal) to the start of an increase in engine output power. The engine response time is an important indicator to measure engine dynamic performance. The braking deceleration refers to a rate at which a speed reduction rate of the vehicle during braking, usually measured in meters per second 2 (m/S2). The braking deceleration reflects the effectiveness of the braking system. A higher braking deceleration can slow or stop the vehicle over a shorter distance, which is essential for a safe stop in an emergency.

The braking distance refers to a distance required for the vehicle to stop completely from a certain speed. The braking distance is an important indicator to measure vehicle safety. A short braking distance can provide more reaction time and space in an emergency, thereby reducing the occurrence of accidents.

The suspension compression amount refers to the degree to which a vehicle's suspension system compresses when subjected to a load (including vehicle weight, acceleration, or braking), and mainly reflects the deformation of the suspension system. In an example of the present disclosure, the degree of compression of the vehicle suspension system is measured by the compression length of the spring, and the unit is millimeter (mm). The suspension compression amount affects the driving stability, comfort and handling of the vehicle. Proper suspension compression can ensure good contact between the wheels and the ground and improve grip.

The suspension rebound speed refers to a speed at which the suspension system returns to its original position after releasing the load. The suspension rebound speed affects vehicle dynamic behavior and ride comfort. Quick rebound can reduce the fluctuation of the vehicle on bumpy roads and improve the handling and stability of the vehicle.

The classified data processing is performed, and the processed data is imported into an integrated AI cloud computing center, specifically including the following steps.

The image data, the point cloud data and the radar data of the time points marked with driving abnormalities are imported into an image feature extraction module, a point cloud geometric feature extraction module and a radar data processing module local to the AI cloud computing center, and corresponding data processing is performed to obtain image feature data, point cloud geometric feature data and radar feature data of the time points marked with driving abnormalities. The image feature data, the point cloud geometric feature data and the radar feature data of the time points marked with driving abnormalities are obtained, specifically including the following steps.

After the image feature extraction module preprocesses the image data of time points marked with driving abnormalities, the oriented features from accelerated segment test and rotated binary robust independent elementary features (ORB) feature extraction algorithm is used to encode the recognized image features (including traffic lights, pedestrians, vehicles and road traffic signs) into feature vectors, and the principal component analysis (PCA) feature selection algorithm is used to screen the feature vectors and summarize the feature vectors into the image feature data of time points marked with driving abnormalities.

After the point cloud geometric feature extraction module preprocesses the point cloud data of time points marked with driving abnormalities, the geometric features including surface normal and curvature of the point cloud are calculated by point cloud library (PCL), and summarized into the point cloud geometric feature data of time points marked with driving abnormalities.

After the radar data processing module preprocesses the radar data of time points marked with driving abnormalities, the moving objects in the radar data are identified and tracked by constant false alarm rate (CFAR) algorithm, and the movement data of each moving object, including the average movement speed, movement direction and movement distance, are extracted, and summarized into the radar characteristic data.

It is to be noted that the ORB feature extraction algorithm is an algorithm for feature detection and description in computer vision. The ORB feature extraction algorithm includes features from accelerated segment test (FAST) key point detection and binary robust independent elementary features (BRIEF) feature descriptor, specifically including the following.

FAST is an algorithm used to detect key points (feature points) in images. Whether a key point exists is determined by comparing a pixel with the surrounding pixels. If a pixel is brighter or darker than enough pixels in its neighborhood, and the pixel is marked as a key point. ORB uses the FAST algorithm to quickly detect key points in images.

BRIEF is a feature descriptor that generates a binary string (i.e. a sequence of 0 and 1) by comparing the brightness of a pair of pixels around a key point. This string is the descriptor of the key point, which is used in the subsequent matching process.

To make the BRIEF descriptor rotation invariant, the ORB algorithm first calculates the direction of each key point. The direction of each key point is usually done by calculating the gradient direction histogram in the neighborhood of key points and finding the main direction. The pair of pixels to which the BRIEF descriptor is compared is rotated according to this orientation, ensuring that the descriptor is not sensitive to image rotation.

ORB achieves scale invariance by constructing a pyramid of images and applying FAST to detect key points at different scales. In this way, key points can be detected at different scales, enabling the algorithm to process image features of different sizes.

The principal component analysis (PCA) is a statistical method that transforms a set of possibly correlated variables into a set of linearly uncorrelated variables by orthogonal transformation, and these new variables are called principal components. PCA is mainly used for data dimensionality reduction, that is, reducing the dimension of data while retaining the original data information as much as possible. In feature selection, PCA can help identify and select the most important features, and PCA includes the following basic steps.

In step 1, the data is normalized. Since PCA is greatly affected by the scale of the data, it is usually necessary to normalize the data first.

In step 2, the covariance matrix is calculated. The covariance matrix describes the correlation between individual features in the data. If the covariance of two features is large, it means that the two features may change together.

In step 3, the eigenvalues and eigenvectors of the covariance matrix are calculated. By calculating the eigenvalues and eigenvectors of the covariance matrix, the main direction (i.e., the principal component) of the data is found.

In step 4, the main components are selected. The magnitude of the eigenvalue represents the magnitude of the variance of the data in the direction of the corresponding eigenvector. The eigenvectors corresponding to the largest eigenvalues are selected, which are the main components of the data.

In step 5, a projection matrix is formed. The selected eigenvectors are combined into a new matrix called the projection matrix. This matrix will be used to project the raw data into a lower dimensional space.

In step 6, the data is converted. The raw data is transformed into a new space using the projection matrix.

In feature selection, PCA can help identify which principal components include most of the information of the data.

By observing the magnitude of the eigenvalues of each principal component to the data, it is possible to determine which raw features contribute the most to the variance of the data. If the first few principal components can explain most of the variance of the data, these principal components can be used instead of the original features, thereby achieving data dimensionality reduction.

The PCL is an open source library for two-dimensional (2D)/3D image and point cloud processing.

The CFAR algorithm is a detection technology used in radar and sonar signal processing. The false alarm rate is maintained at a predetermined level by adaptively adjusting the detection threshold, even with changing environmental noise or interference levels. CFAR algorithm is widely used in target detection in radar systems to ensure that real targets can be stably identified in complex background noise.

Image feature data is used to identify key visual elements in the driving environment and detect abnormal events (including vehicle departure from lane, collision, etc.).

The point cloud geometric feature data is used to provide 3D structural information of the surrounding environment, and geometric features including surface normals and curvatures are used to identify and classify obstacles on the road, including pedestrians, vehicles, etc. The surface normals are used to represent vectors of surface directions for points in the point cloud. The curvature is a quantity that describes the degree of curvature of the surface of the point cloud and is used to identify the shape of the object.

Radar data obtains dynamic information of objects in the scene through recognition and path tracking of moving objects, including an average moving speed, moving direction and moving distance of each object. The dynamic information is mainly used to analyze the speed state and relative position of vehicles, and determine whether there are abnormal driving situations including rear-end collision and keeping a safe distance.

The control system data of time points marked with driving abnormalities is compared and analyzed with the pre-stored control system data check set in the local database. The control system data check set includes an engine response time threshold, a braking deceleration threshold, a braking distance threshold, a suspension compression threshold and a suspension rebound speed threshold. The control system state feature value of time points marked with driving abnormalities is obtained, and the feature value of the control system state of time points marked with driving abnormalities is used to confirm whether the control system of time points marked with driving abnormalities is normal or not.

$$\begin{matrix}{KZ}_{i} = exp ( \frac{{t}_{i}}{{t}_{0}} * {β}_{1} + \frac{{l}_{i}}{{l}_{0}} * {β}_{2} ) + tanh ( \frac{\vert {ys}_{i} - {ys}_{0} \vert}{{ys}_{0}} * {β}_{3} ) + exp {( \frac{{v}_{i}}{{v}_{0}} * {β}_{4} + \frac{{htv}_{i}}{{htv}_{0}} * {β}_{5} )}^{- 1} \\ {Z}_{r} = \frac{{X}_{r} - μ {X}_{r}}{σ {X}_{r}}\end{matrix}$$

where Zᵣ is a standardization processing result of the rₜₕ feature, Xᵣ is the rₜₕ feature, μXᵣ is an average value of the rₜₕ feature, σXᵣ is a standard deviation of the rₜₕ feature, r is a number of the feature, r=1, 2, 3, . . . , R, R is a total amount of the feature, and the processed data is recorded as a data set of time points marked with driving abnormalities.

The K-means clustering is a typical machine learning unsupervised learning method, which is used to divide the data set of time points marked with driving abnormalities into several clusters included by similar elements. The data points in the data set of time points marked with driving abnormalities are assigned to K clusters, and the sum of the square distances between each data point and its assigned cluster center is minimized. The basic steps and principles of K-means clustering are as follows.

In step 1, K data points are randomly selected as the initial cluster center (centroid).

In step 2, for each data point, a distance between the data point and each cluster center is calculated and assigned to the cluster represented by the nearest cluster center.

In step 3, the center of each cluster is recalculated, the mean value of all points in the cluster is usually taken as the new cluster center.

In step 4, step 2 and step 3 are repeated until a stop condition is satisfied. In an example of the present disclosure, the stop condition is that the preset number of iterations is reached.

In examples of the present disclosure, the Euclidean distance is used to measure the similarity between data points, and other distance measurement methods including Manhattan distance or cosine similarity may be used in other examples of the present disclosure.

The K-means algorithm aims to minimize the square error within the cluster, and its objective function can be expressed as:

$$J = {\sum }_{k = 1}^{K} {\sum }_{{x}_{j} ∈ {S}_{k}} {‖ {x}_{j} - {μ}_{k} ‖}^{2}$$

where J is an objective function of K-means, Sₖ is the kth cluster, xⱼ is the jₜₕ data point in Sₖ, μₖ is a center of Sₖ, k is a number of clusters, k=1, 2, 3, . . . , K, K is a total number of clusters, j is a data point number of Sₖ, j=1, 2, 3, . . . , N, and Nis a total number of data points of Sₖ. It is to be noted that the K value is preset, and in the example of the present disclosure, the K value is set as the number of abnormal scene tags.

The data features of each abnormal cluster is compared with the feature template corresponding to each abnormal scene label pre-stored in the integrated AI cloud computing center. In an example of the present disclosure, the Euclidean distance is used to calculate the similarity between the current abnormal cluster data feature and a certain feature in the feature template corresponding to the pre-stored abnormal scene label, and specifically including the following steps.

An expression of the eigenvector of the data features of a certain abnormal cluster is assumed to be X=(a₁, a₂, a₃, . . . , [symbol] ).

An eigenvector expression of a certain feature of the template corresponding to an abnormal scene tag is assumed to be Y=(b₁, b₂, b₃, . . . , [symbol] ).

$$d ( X , Y ) = \sqrt{{\sum }_{ε = 1}^{ϱ} {( {a}_{ε} - {b}_{ε} )}^{2}}$$

where d(X, Y) is a similarity degree of a certain feature in a feature template corresponding to the abnormal cluster data feature and the abnormal scene label, ε is a number of each vector in the eigenvector expression, ε=1, 2, 3, . . . , [symbol] , and [symbol] is a total number of vectors.

According to the similarity calculation results, a machine learning classifier is used to determine whether the data features of each abnormality cluster match each abnormality scene label. If the classifier determines that data features of each abnormality cluster match each abnormal scene label, the corresponding abnormal scene label is assigned to the current abnormal cluster data feature.

The Euclidean distance refers to a true distance between two points in an m-dimensional space, or a natural length of the vector (i.e. a distance from the point to an origin).

The processed comprehensive scene data of time points marked with driving abnormalities is stored in a database under each corresponding abnormal scene label based on each abnormal scene label of the time points marked with driving abnormalities.

For example, when the abnormal scene label of a time point marked with driving abnormality includes “rear-end collision”, “sudden braking”, and “collision”, the processed comprehensive scene data of the time point marked with driving abnormality is stored in the database under the labels “rear-end collision”, “sudden braking”, and “collision”, and put into the integrated AI cloud computing center for learning and updating. When scene data similar to the time point marked with driving abnormality appears again, the integrated AI cloud computing center can identify and mark the abnormal scene.

It is also to be specifically noted that the abnormal scene labels at a certain time point marked with driving abnormality include “rear-end collision”, “sudden braking” and “collision”. For example, for the “rear-end collision”, the features in the feature template of this abnormal scene label include a speed change feature, a following distance feature, an acceleration change feature, and a rear deformation degree feature of the preceding vehicle.

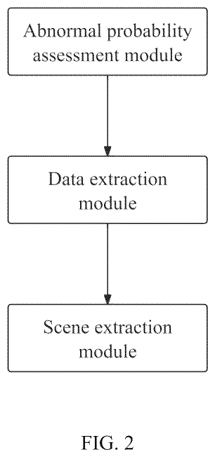

In the present example, as shown in FIG. 2, the present disclosure provides a system for extracting abnormal scenes from driving data of intelligent vehicles based on AI, specifically including:
an abnormal risk assessment module, configured to retrieve the basic information of each intelligent vehicle from a plurality of data transmission terminals, analyze and process the basic information to obtain abnormal risk assessment values of each intelligent vehicle, and match to obtain a driving data extraction ratio of each intelligent vehicle based on the abnormal risk assessment values of each intelligent vehicle;
a data extraction module, configured to acquire driving data packets of each intelligent vehicle based on the driving data extraction ratio of each intelligent vehicle, simultaneously acquire time points marked with driving abnormalities, statistically record comprehensive scene data of the time points marked with driving abnormalities from the driving data packets, perform classified data processing, and import the processed data into an integrated AI cloud computing center; and
a scene extraction module, configured to receive the processed comprehensive scene data of time points marked with driving abnormalities by the integrated AI cloud computing center, and perform clustering processing to generate and store abnormal scene data of each intelligent vehicle.

It is to be noted that in the present disclosure, relational terms including first and second, and the like, may be used herein to distinguish one entity or orientation from another entity or orientation without necessarily requiring or implying any actual such relationship or order between the entities or orientations. Furthermore, the terms “including”, “comprising”, or any other variations thereof, are intended to cover non-exclusive inclusion, and a process, method, article, or apparatus including a series of elements includes not only those elements, but also other elements not explicitly listed, or elements inherent to such process, method, article, or apparatus.

The preferred examples of the present disclosure disclosed above are intended only to help illustrate the present disclosure. The preferred examples are not intended to be exhaustive in all details, and the preferred examples are not intended to limit the present disclosure to specific embodiments. Obviously, many modifications and changes can be made according to the contents of this specification These examples are selected and described in detail in this specification in order to better explain the principle and practical application of the present disclosure, those skilled in the art can better understand and make use of the present disclosure, all these examples belong to the protection scope of the present disclosure as long as they do not deviate from the structure of the present disclosure or exceed the scope defined by the present disclosure.

1. A method for extracting abnormal scenes from driving data of intelligent vehicles based on artificial intelligence (AI), comprising the steps of:
retrieving basic information of various intelligent vehicles from a plurality of data transmission terminals, and analyzing and processing the basic information to obtain abnormal risk assessment values of the various intelligent vehicles, followed by matching to obtain a driving data extraction ratio of each intelligent vehicle based on the abnormal risk assessment values of the various intelligent vehicles,
acquiring driving data packets of various intelligent vehicles based on the driving data extraction ratio of each intelligent vehicle, simultaneously acquiring time points marked with driving abnormalities, statistically recording comprehensive scene data of the time points marked with driving abnormalities from the driving data packets, performing classified data processing, and importing the processed data into an integrated AI cloud computing center, and
receiving the processed comprehensive scene data of time points marked with driving abnormalities by the integrated AI cloud computing center, and performing clustering processing to generate and store abnormal scene data of each intelligent vehicle, wherein
the performing classified data processing, and importing the processed data into an integrated AI cloud computing center specifically comprises the steps of:
importing image data, point cloud data and radar data of the time points marked with driving abnormalities into an image feature extraction module, a point cloud geometric feature extraction module and a radar feature extraction module local to the AI cloud computing center, and performing corresponding data processing to obtain image feature data, point cloud geometric feature data and radar feature data of the time points marked with driving abnormalities;
comparing and analyzing control system data of the time points marked with driving abnormalities with a pre-stored control system data check set in a local database to obtain a control system state characteristic value of the time points marked with driving abnormalities, wherein the control system state characteristic value of the time points marked with driving abnormalities is used for confirming whether a control system of time points marked with driving abnormalities is normal or not, it is determined that the control system of at a certain time point marked with driving abnormality is abnormal if the control system state characteristic value at the certain time point marked with driving abnormality is greater than or equal to a preset control system state abnormal threshold value; and it is determined that the control system state characteristic value at a certain time point marked with driving abnormality is normal if the control system state characteristic value at the certain time point marked with driving abnormality is less than the control system state abnormal threshold value;
statistically recording the time points marked with driving abnormalities when the control system is abnormal as time points marked with each abnormal control system, and storing image feature data, point cloud geometric feature data and radar feature data of the time points marked with each abnormal control system in a database under a label of the abnormal control system;
the control system data check set comprising an engine response time threshold, a braking deceleration threshold, a braking distance threshold, a suspension compression threshold, and a suspension rebound speed threshold; and
collectively recording the image feature data, the point cloud geometric feature data, and the radar feature data of the time points marked with driving abnormalities when the control system is normal as processed comprehensive scene data of the time points marked with driving abnormalities.

2. The method for extracting abnormal scenes from driving data of intelligent vehicles based on AI according to claim 1, wherein the retrieving basic information of each intelligent vehicle from a plurality of data transmission terminals specifically comprises the steps of:
initiating a connection request from the integrated AI cloud computing center to each data transmission terminal, and packaging and transmitting the basic information of each intelligent vehicle to a central server of the integrated AI cloud computing center after each data transmission terminal receives the connection request,
the basic information of each intelligent vehicle comprising an accumulated mileage, an accumulated duration, and an accumulated number of failures of each intelligent vehicle.

3. The method for extracting abnormal scenes of intelligent vehicles driving data based on AI according to claim 1, wherein the analyzing and processing the basic information to obtain abnormal risk assessment values of each intelligent vehicle specifically comprises the steps of:
analyzing and processing the basic information of each intelligent vehicle to obtain a basic information average value set and a basic information median value set,
the basic information average value set comprising an accumulated average mileage, an accumulated average duration, and an accumulated average number of failures; and
the basic information median value set comprising a median value of accumulated mileage, a median value of accumulated duration, and a median value of accumulated number of failures;
comprehensively analyzing and processing the basic information average value set and the basic information median value set to obtain a basic information median adjusted average value set, comprising an accumulated median adjusted average mileage, an accumulated median adjusted average duration and an accumulated median adjusted average number of failures; and
comparing and analyzing the basic information of each intelligent vehicle and the basic information median adjusted average value set to obtain the abnormal risk assessment value of each intelligent vehicle, and the abnormal risk assessment value of each intelligent vehicle being used to characterize abnormal risks of each intelligent vehicle during driving.

4. The method for extracting abnormal scenes of intelligent vehicles driving data based on AI according to claim 1, wherein the matching to obtain driving data extraction ratio of each intelligent vehicle based on the abnormal risk assessment values of each intelligent vehicle specifically comprises the steps of:
performing mapping and matching on a driving data extraction ratio corresponding to each abnormal risk assessment value interval in a built-in database of the integrated AI cloud computing center based on the abnormal risk assessment value of each intelligent vehicle, and obtaining a driving data extraction ratio of each intelligent vehicle.

5. The method for extracting abnormal scenes of intelligent vehicles driving data based on AI according to claim 1, wherein the acquiring time points marked with driving abnormalities, and statistically recording comprehensive scene data of the time points marked with driving abnormalities from the driving data packets specifically comprises the steps of:
identifying time points marked with driving abnormalities in the driving data packets of each intelligent vehicle, statistically recording longitudinal abnormality time point data and horizontal abnormality time period data of the time points marked with driving abnormalities, and synthesizing the same as the comprehensive scene data of time points marked with driving abnormalities,
the comprehensive scene data of the time points marked with driving abnormalities comprising environmental perception data and control system data of the time points marked with driving abnormalities,
the environment perception data comprising the image data, the point cloud data, and the radar data of the time points marked with driving abnormalities; and
the control system data comprising an engine response time, a braking deceleration, a braking distance, a suspension compression amount, and a suspension rebound speed of the time points marked with driving abnormalities.

6. The method for extracting abnormal scenes of intelligent vehicles driving data based on AI according to claim 1, wherein the receiving the processed comprehensive scene data of time points marked with driving abnormalities by the integrated AI cloud computing center, and performing clustering processing to generate and store abnormal scene data of each intelligent vehicle specifically comprises the steps of:
receiving the processed comprehensive scene data of the time points marked with driving abnormalities by the integrated AI cloud computing center, performing K-means clustering processing and analysis to obtain a plurality of abnormal scene characteristic clusters of the time points marked with driving abnormalities, obtaining data features of each abnormal cluster of the time points marked with driving abnormalities after iterative update, and matching the data features of each abnormal cluster of time points marked with driving abnormalities with corresponding abnormal scene labels pre-stored in the integrated AI cloud computing center to obtain each abnormal scene label of the time points marked with driving abnormalities; and
storing the processed comprehensive scene data of time points marked with driving abnormalities in a database under each corresponding abnormal scene label based on each abnormal scene label of the time points marked with driving abnormalities.

7. The method for extracting abnormal scenes of intelligent vehicles driving data based on AI according to claim 1, further comprising detecting transmission channel performance parameters from each data transmission terminal to the integrated AI cloud computing center, processing, analyzing and generating data quality repair factor and performing data quality repair, specifically comprising the steps of:
the transmission channel performance parameters comprising a real-time signal strength, an interface rate, real-time delay and real-time signal-to-noise ratio (SNR) of each data transmission terminal;
retrieving transmission channel performance verification parameters from the built-in database of the integrated AI cloud computing center, comprising a real-time signal strength check value, an interface rate check value, a real-time delay check value and a real-time SNR check value; and
comprehensively comparing and analyzing the transmission channel performance parameters and the transmission channel performance verification parameters to obtain data quality influence values of each transmission channel, mapping and matching the data quality influence values of each transmission channel with data quality repair factors corresponding to data quality influence value intervals pre-stored in the built-in database of the integrated AI cloud computing center to obtain data quality repair factors of each transmission channel; and the data quality influence values of each transmission channel being used to characterize the influence of the performance of each transmission channel on the data quality, and repairing data quality based on the data transmission repair factors.

8. The method for extracting abnormal scenes of intelligent vehicles driving data based on AI according to claim 3, wherein the analyzing and processing the basic information to obtain abnormal risk assessment values of each intelligent vehicle specifically comprises the steps of:
$${A}_{m} = softplus [ \frac{{L}_{m}}{{L}_{re}} * {μ}_{1} + \frac{{T}_{m}}{{T}_{re}} * {μ}_{2} + \frac{{L}_{m}}{{C}_{re}} * {μ}_{3} ]$$
where Aₘ is an abnormal risk assessment value of mₜₕ intelligent vehicle, Lₘ is an accumulated mileage of mₜₕ intelligent vehicle, Tₘ is an accumulated duration of mₜₕ intelligent vehicle, and Lₘ is an accumulated number of failures of mₜₕ intelligent vehicle; L̅ is an accumulated average mileage, T̅ is an accumulated average duration, and C̅ is an accumulated average number of failures; L_{middle} is a median value of accumulated mileage, T_{middle} is a median value of accumulated duration, and C_{middle} is a median value of accumulated number of failures; Lᵣₑ is an accumulated median adjusted average mileage, Tᵣₑ is an accumulated median adjusted average duration, and Cᵣₑ is an accumulated median adjusted average number of failures; μ₁ is a weight factor of the accumulated mileage, μ₂ is a weight factor of the accumulated duration, and μ₃ is a weight factor of the accumulated average number of failures; and ω₁ is an average value adjustment proportional coefficient, ω₂ is a median value adjustment proportional coefficient, m is a number of the intelligent vehicle, m=1, 2, 3, . . . , y, y is a total number of intelligent vehicles, and the softplus function is a built-in function in Python, softplus(x)=lg(1+e^{x}).

9. A system for extracting abnormal scenes from driving data of intelligent vehicles based on AI according to claim 1, comprising:
an abnormal risk assessment module, configured to retrieve the basic information of each intelligent vehicle from a plurality of data transmission terminals, analyze and process the basic information to obtain abnormal risk assessment values of each intelligent vehicle, and obtain a driving data extraction ratio of each intelligent vehicle through matching based on the abnormal risk assessment values of each intelligent vehicle;
a data extraction module, configured to acquire driving data packets of each intelligent vehicle based on the driving data extraction ratio of each intelligent vehicle, simultaneously acquire time points marked with driving abnormalities, statistically record comprehensive scene data of the time points marked with driving abnormalities from the driving data packets, perform classified data processing, and import the processed data into an integrated AI cloud computing center; and
a scene extraction module, configured to receive the processed comprehensive scene data of time points marked with driving abnormalities by the integrated AI cloud computing center, and perform clustering processing to generate and store abnormal scene data of each intelligent vehicle.

10. A system for extracting abnormal scenes from driving data of intelligent vehicles based on AI according to claim 2, comprising:
an abnormal risk assessment module, configured to retrieve the basic information of each intelligent vehicle from a plurality of data transmission terminals, analyze and process the basic information to obtain abnormal risk assessment values of each intelligent vehicle, and obtain a driving data extraction ratio of each intelligent vehicle through matching based on the abnormal risk assessment values of each intelligent vehicle;
a data extraction module, configured to acquire driving data packets of each intelligent vehicle based on the driving data extraction ratio of each intelligent vehicle, simultaneously acquire time points marked with driving abnormalities, statistically record comprehensive scene data of the time points marked with driving abnormalities from the driving data packets, perform classified data processing, and import the processed data into an integrated AI cloud computing center; and
a scene extraction module, configured to receive the processed comprehensive scene data of time points marked with driving abnormalities by the integrated AI cloud computing center, and perform clustering processing to generate and store abnormal scene data of each intelligent vehicle.

11. A system for extracting abnormal scenes from driving data of intelligent vehicles based on AI according to claim 3, comprising:
an abnormal risk assessment module, configured to retrieve the basic information of each intelligent vehicle from a plurality of data transmission terminals, analyze and process the basic information to obtain abnormal risk assessment values of each intelligent vehicle, and obtain a driving data extraction ratio of each intelligent vehicle through matching based on the abnormal risk assessment values of each intelligent vehicle;
a data extraction module, configured to acquire driving data packets of each intelligent vehicle based on the driving data extraction ratio of each intelligent vehicle, simultaneously acquire time points marked with driving abnormalities, statistically record comprehensive scene data of the time points marked with driving abnormalities from the driving data packets, perform classified data processing, and import the processed data into an integrated AI cloud computing center; and
a scene extraction module, configured to receive the processed comprehensive scene data of time points marked with driving abnormalities by the integrated AI cloud computing center, and perform clustering processing to generate and store abnormal scene data of each intelligent vehicle.

12. A system for extracting abnormal scenes from driving data of intelligent vehicles based on AI according to claim 4, comprising:
an abnormal risk assessment module, configured to retrieve the basic information of each intelligent vehicle from a plurality of data transmission terminals, analyze and process the basic information to obtain abnormal risk assessment values of each intelligent vehicle, and obtain a driving data extraction ratio of each intelligent vehicle through matching based on the abnormal risk assessment values of each intelligent vehicle;
a data extraction module, configured to acquire driving data packets of each intelligent vehicle based on the driving data extraction ratio of each intelligent vehicle, simultaneously acquire time points marked with driving abnormalities, statistically record comprehensive scene data of the time points marked with driving abnormalities from the driving data packets, perform classified data processing, and import the processed data into an integrated AI cloud computing center; and
a scene extraction module, configured to receive the processed comprehensive scene data of time points marked with driving abnormalities by the integrated AI cloud computing center, and perform clustering processing to generate and store abnormal scene data of each intelligent vehicle.

13. A system for extracting abnormal scenes from driving data of intelligent vehicles based on AI according to claim 5, comprising:
an abnormal risk assessment module, configured to retrieve the basic information of each intelligent vehicle from a plurality of data transmission terminals, analyze and process the basic information to obtain abnormal risk assessment values of each intelligent vehicle, and obtain a driving data extraction ratio of each intelligent vehicle through matching based on the abnormal risk assessment values of each intelligent vehicle;
a data extraction module, configured to acquire driving data packets of each intelligent vehicle based on the driving data extraction ratio of each intelligent vehicle, simultaneously acquire time points marked with driving abnormalities, statistically record comprehensive scene data of the time points marked with driving abnormalities from the driving data packets, perform classified data processing, and import the processed data into an integrated AI cloud computing center; and
a scene extraction module, configured to receive the processed comprehensive scene data of time points marked with driving abnormalities by the integrated AI cloud computing center, and perform clustering processing to generate and store abnormal scene data of each intelligent vehicle.

14. A system for extracting abnormal scenes from driving data of intelligent vehicles based on AI according to claim 6, comprising:
an abnormal risk assessment module, configured to retrieve the basic information of each intelligent vehicle from a plurality of data transmission terminals, analyze and process the basic information to obtain abnormal risk assessment values of each intelligent vehicle, and obtain a driving data extraction ratio of each intelligent vehicle through matching based on the abnormal risk assessment values of each intelligent vehicle;
a data extraction module, configured to acquire driving data packets of each intelligent vehicle based on the driving data extraction ratio of each intelligent vehicle, simultaneously acquire time points marked with driving abnormalities, statistically record comprehensive scene data of the time points marked with driving abnormalities from the driving data packets, perform classified data processing, and import the processed data into an integrated AI cloud computing center; and
a scene extraction module, configured to receive the processed comprehensive scene data of time points marked with driving abnormalities by the integrated AI cloud computing center, and perform clustering processing to generate and store abnormal scene data of each intelligent vehicle.

15. A system for extracting abnormal scenes from driving data of intelligent vehicles based on AI according to claim 7, comprising:
an abnormal risk assessment module, configured to retrieve the basic information of each intelligent vehicle from a plurality of data transmission terminals, analyze and process the basic information to obtain abnormal risk assessment values of each intelligent vehicle, and obtain a driving data extraction ratio of each intelligent vehicle through matching based on the abnormal risk assessment values of each intelligent vehicle;
a data extraction module, configured to acquire driving data packets of each intelligent vehicle based on the driving data extraction ratio of each intelligent vehicle, simultaneously acquire time points marked with driving abnormalities, statistically record comprehensive scene data of the time points marked with driving abnormalities from the driving data packets, perform classified data processing, and import the processed data into an integrated AI cloud computing center; and
a scene extraction module, configured to receive the processed comprehensive scene data of time points marked with driving abnormalities by the integrated AI cloud computing center, and perform clustering processing to generate and store abnormal scene data of each intelligent vehicle.

16. A system for extracting abnormal scenes from driving data of intelligent vehicles based on AI according to claim 8, comprising:
an abnormal risk assessment module, configured to retrieve the basic information of each intelligent vehicle from a plurality of data transmission terminals, analyze and process the basic information to obtain abnormal risk assessment values of each intelligent vehicle, and obtain a driving data extraction ratio of each intelligent vehicle through matching based on the abnormal risk assessment values of each intelligent vehicle;
a data extraction module, configured to acquire driving data packets of each intelligent vehicle based on the driving data extraction ratio of each intelligent vehicle, simultaneously acquire time points marked with driving abnormalities, statistically record comprehensive scene data of the time points marked with driving abnormalities from the driving data packets, perform classified data processing, and import the processed data into an integrated AI cloud computing center; and
a scene extraction module, configured to receive the processed comprehensive scene data of time points marked with driving abnormalities by the integrated AI cloud computing center, and perform clustering processing to generate and store abnormal scene data of each intelligent vehicle.
